(19) United States
(12) Patent Application Publication
(10) Pub. No.: US 2026/0307719 A1
(43) Pub. Date: Oct. 8, 2026

(54) VEHICLE BODY JOINT STRUCTURE

(71) Applicants: Kia Corporation, Seoul (KR); Hyundai Motor Company, Seoul (KR)

(72) Inventors: Hyuncheol Yun, Hwaseong-si (KR); Chulhee Heo, Hwaseong-si (KR); Jongduk Yu, Hwaseong-si (KR)

(21) Appl. No.: 19/551,147

(22) Filed: Feb. 26, 2026

(30) Foreign Application Priority Data
Apr. 2, 2025 (KR) 10-2025-0042540
Oct. 29, 2025 (KR) 10-2025-0158784

(51) Int. Cl. B62D 21/15

(52) U.S. Cl. CPC B62D 21/152

(57) ABSTRACT

A vehicle body joint structure of a vehicle body may include a chassis cab included in a cabin portion and a special portion connected to the outer side of the chassis cab, and the vehicle body joint structure may include side planarization members connected to lower ends on both sides of an outer side of the cabin portion and arranged to extend in the length direction of the vehicle body, lower side vertical members installed on the lower ends on both sides of the inner side of the cabin portion and arranged to extend in the height direction of the vehicle, and a center floor side member connected to the lower side vertical member and arranged to extend in the length direction of the vehicle body.

### CROSS-REFERENCE TO RELATED APPLICATIONS

This application claims priority to and the benefit of Korean Patent Application No. 10-2025-0042540 filed with the Korean Intellectual Property Office on Apr. 2, 2025, and Korean Patent Application No. 10-2025-0158784 filed with the Korean Intellectual Property Office on Oct. 29, 2025, the entire contents of which are incorporated herein by reference.

### TECHNICAL FIELD

The present disclosure relates to a vehicle body joint structure.

### BACKGROUND

Recently, the automobile industry has been introducing a new concept of future mobility vision for realizing a dynamic, human-centered future city. One such future mobility solution is purpose-built vehicles (PBVs), vehicles designed for purpose-based mobility.

PBV vehicles may be exemplified by eco-friendly mobility vehicles based on electric vehicles (EVs).

The vehicle body of such PBV vehicles may include a cabin portion, which is the passenger space, and a special portion, where luggage is placed, and the outer side of the cabin portion is manufactured as a cutaway-type chassis cab with the panel removed.

However, as shown in FIGS. 1 and 2, in the case of a chassis cab vehicle manufactured with a monocoque platform 1 applied to a multi-specification PBV vehicle (passenger van, cargo van), an overall height size (d) of the rear portion of a cabin portion 3 is expanded due to a low-floor application. In this structure, a rear load pass connection structure is required to satisfy the rear crash performance of a low-floor PBV chassis cab. In addition, it is necessary to expand the installation region of a safety device to prevent luggage placed in the special portion at the rear of the cabin portion 3 from intruding into the cabin portion 3.

### SUMMARY

The present disclosure relates to a vehicle body joint structure, and relates to a vehicle body joint structure in which a plurality of crossmembers, vertical members, and gussets are installed on the inner side of a cabin portion of a chassis cab body type vehicle, thereby improving the load path to distribute the impact load in the event of a rear collision of the vehicle.

Accordingly, some embodiments of the present disclosure may solve the above-described problems, and to provide a vehicle body joint structure capable of improving the rigidity of the vehicle body and alleviating impact caused by a rear collision by installing a plurality of crossmembers, vertical members, and gussets on the inner side of a cabin portion in a chassis cab body type vehicle.

A vehicle body joint structure according to an embodiment of the present disclosure may be a vehicle body joint structure including a chassis cab included in a cabin portion and a special portion connected to the outer side of the chassis cab, which may include side planarization members connected to the lower ends on both sides of the outer side of the cabin portion and arranged to extend in the length direction of the vehicle, lower side vertical members installed on the lower ends on both sides of the inner side of the cabin portion and arranged to extend in the height direction of the vehicle, and a center floor side member connected to the lower side vertical member and arranged to extend in the length direction of the vehicle body.

One end of the side planarization member may be connected to the lower side vertical member by a lower side gusset.

The side planarization member may be connected to an upper surface of a front support reinforcement installed to support the outer surface of the cabin portion.

A lower side bottom reinforcement may be interposed between the lower portion of the lower side vertical member and a lower inner side of the vehicle body.

A vehicle body joint structure according to an embodiment of the present disclosure may further include a partition panel included in a vertical cross-section of the cabin portion, and an upper crossmember installed on the inner side of the cabin portion and extending in a direction perpendicular to the height direction of the vehicle body on the upper inner surface of the partition panel.

Both sides of the upper crossmember may be fixed to the upper inner surface of the partition panel by an upper side gusset.

A vehicle body joint structure according to an embodiment of the present disclosure may further include a pair of center side crossmembers installed on the inner side of the cabin portion and extending in a direction perpendicular to the height direction of the vehicle body on both inner surfaces of the central portion of the partition panel.

One side of the center side crossmember may be fixed to the inner surface of the central portion of the partition panel by a center side gusset.

A vehicle body joint structure according to an embodiment of the present disclosure may further include a center crossmember installed on the inner side of the cabin portion and extending in a direction perpendicular to the height direction of the body between the pair of center side crossmembers on the inner surface of the central portion of the partition panel.

A vehicle body joint structure according to an embodiment of the present disclosure may further include a center lower crossmember installed on the inner side of the cabin portion and extending in a direction perpendicular to the height direction of the vehicle body on the lower inner surface of the partition panel.

A vehicle body joint structure according to an embodiment of the present disclosure may further include a center vertical member installed on the inner side of the cabin portion, extending in the height direction of the vehicle body on the inner surface of the central portion of the partition panel, and installed to connect the upper crossmember and the center lower crossmember.

One side of the center vertical member may be connected to the center side crossmember, and the other side may be connected to the center crossmember.

A vehicle body joint structure according to an embodiment of the present disclosure may further include a lower vertical member installed on the inner side of the cabin portion, and installed on the lower inner surface of the partition panel to connect the center side crossmember and the center lower crossmember.

The upper portion of the lower side vertical member may be connected to the lower vertical member, and the lower portion of the lower side vertical member may be connected to the lower inner side of the vehicle body.

One side of the lower vertical member may be fixed to the lower inner surface of the partition panel by the lower side gusset.

The other side of the lower vertical member may be connected to the end of the center lower crossmember on the lower inner surface of the partition panel.

The impact transmitted from the lower rear portion of the vehicle body to the cabin portion may be transmitted to the center floor side member through the side planarization member, the front support reinforcement, and the lower side vertical member.

The impact transmitted from the lower rear portion of the vehicle body to the cabin portion may be transmitted to the side planarization member, the front support reinforcement, and the lower side vertical member, and the impact transmitted to the lower side vertical member may be distributed and transmitted to the center lower crossmember and the lower side bottom reinforcement.

The impact transmitted from the rear center of the vehicle body to the cabin portion may be distributed and transmitted from the center vertical member to the upper crossmember, the center side crossmember, the center lower crossmember, and the center crossmember.

According to an embodiment of the present disclosure, by installing a plurality of crossmembers, vertical members, and gussets on the inner side of the cabin portion in a chassis cab body type vehicle, it may be possible to improve the rigidity of the vehicle body and alleviate the impact caused by a rear collision to protect the cabin portion.

In some embodiments, by securing the rigidity of the vehicle body, damage to the battery installed in the vehicle may be prevented, and safety of passengers may be improved.

In some embodiments, the position and number of crossmembers, vertical members, and gussets may be changed to adapt to the size and shape of the vehicle, allowing for easy and flexible adaptation to multi-specification vehicle models, reducing investment and research and development costs, and increasing productivity.

### BRIEF DESCRIPTION OF THE DRAWINGS

FIG. 1 illustrates a side view of a vehicle to which a vehicle body joint structure according to an example embodiment of the present disclosure is applied.

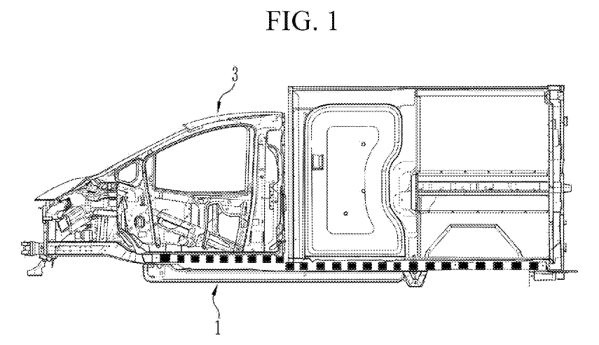

FIG. 2 illustrates a rear view of a vehicle to which a vehicle body joint structure according to an example embodiment of the present disclosure is applied.

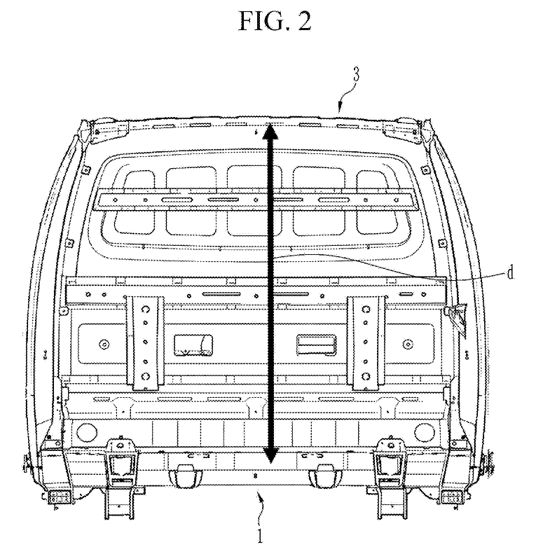

FIG. 3 illustrates the path of an impact transmitted from the rear of a vehicle to a cabin portion to which a vehicle body joint structure according to an example embodiment of the present disclosure is applied.

FIG. 4 illustrates a vehicle body joint structure according to an example embodiment of the present disclosure.

FIG. 5 is an enlarged view of a lower side reinforcement structure of a vehicle body in a vehicle body joint structure according to an example embodiment of the present disclosure.

FIG. 6 illustrates a path of an impact transmitted from a lower rear portion of a vehicle body to a cabin portion in a vehicle body joint structure according to an example embodiment of the present disclosure, as viewed from a side of the vehicle.

FIG. 7 illustrates a path of an impact transmitted from a lower rear portion of a vehicle body to a cabin portion in a vehicle body joint structure according to an example embodiment of the present disclosure, as viewed from an inner side of the cabin portion toward the rear of the vehicle.

FIG. 8 illustrates the path of an impact transmitted from a rear center of a vehicle body to a cabin portion in a vehicle body joint structure according to an example embodiment of the present disclosure, as viewed from an inner side of the cabin portion toward the rear of the vehicle.

### DETAILED DESCRIPTION OF ILLUSTRATIVE EMBODIMENTS

Next, the present disclosure will be described in detail with reference to the accompanying drawings, in which some example embodiments of the present disclosure are shown. As those skilled in the art may realize, the described example embodiments may be modified in various different ways for other embodiments, without departing from the spirit or scopes of the present disclosure.

In various example embodiments, components having the same configuration may representatively described using the same reference numerals, and in other embodiments, only configurations different from those of the representative embodiment may be described.

The drawings are schematic and not necessarily drawn to scale. The relative dimensions and proportions of parts in the drawings may be exaggerated or reduced in size for clarity and convenience, and any dimensions are for illustrative purposes only and are not necessarily limiting. Where identical structures, elements, or parts appear in two or more drawings, like reference numerals may be used to indicate like features. When it is stated that a part is “on” or “above” another part, it can be directly on the other part, or other parts may be disposed therebetween.

The present disclosure specifically illustrates example embodiments of the present disclosure. As a result, many variations of the present disclosure may be expected for other embodiments. Therefore, the present disclosure is not necessarily limited to a particular shape of the illustrated region, but also include modifications of the shape—for example, variations of the shape by manufacturing for other embodiments.

Next, with reference to drawings, a vehicle body joint structure according to example embodiments of the present disclosure will be described.

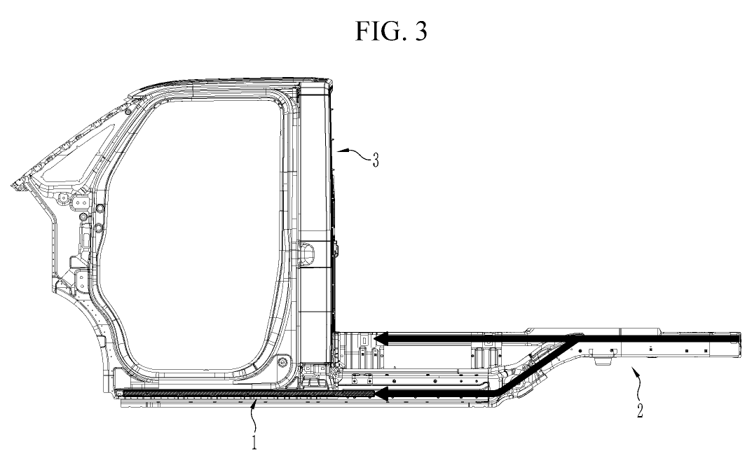

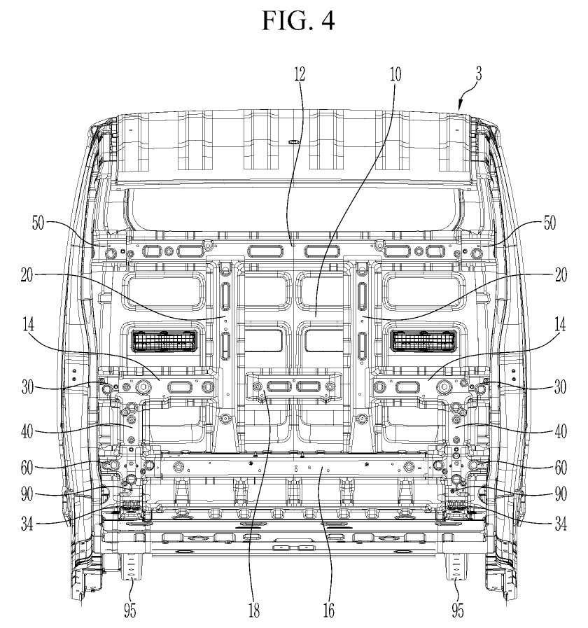

FIG. 3 illustrates a path of an impact transmitted from the rear of the vehicle to a cabin portion to which the vehicle body joint structure according to an example embodiment of the present disclosure is applied. FIG. 4 illustrates a vehicle body joint structure according to an example embodiment of the present disclosure.

A vehicle body joint structure according to an example embodiment of the present disclosure may be applied to a purpose-built vehicle (PBV) of a monocoque body type, and the vehicle body may include a low-floor monocoque platform 1 and a CTBA mounting portion 2 formed to extend from the low-floor monocoque platform 1 and on which a coupled torsion beam axle (CTBA) may be mounted.

In some embodiments, cabin portion 3 that serves as a space for passengers may be formed in the front portion of the monocoque platform 1, the cabin portion 3 may be formed of a cutaway chassis cab, and the CTBA mounting portion 2 connected to the outer side of the chassis cab may function as a special portion where cargo is placed.

In some embodiments, a plurality of planarization members and a plurality of reinforcements may be provided on the upper portion of the monocoque platform 1 so that the upper surfaces of the planarization members, the upper surfaces of the reinforcements, and the upper surface of the vehicle body of the CTBA mounting portion 2 may be formed in a flat shape of the same height.

In other words, in some embodiments, by forming a flat surface between the monocoque platform 1 side and the CTBA mounting portion 2 side, the special portion may be planarized, and also, the load applied to the vehicle body in the event of a rear collision may be distributed.

As shown in FIG. 4, in some embodiments, a partition panel 10 forming a vertical cross-section of the cabin portion 3 may be provided in the cabin portion 3. On the inner side of the cabin portion 3 of the partition panel 10, inner B-pillars may be installed on both sides so as to extend in the height direction of the vehicle body. The inner B-pillars may be installed as a pair facing each other on both inner surfaces of the partition panel 10.

In some embodiments, on the inner side of the cabin portion 3, an upper crossmember 12 may be installed so as to extend in a direction perpendicular to the height direction of the vehicle body on the upper inner surface of the partition panel 10. The upper crossmember 12 may be installed so as to be connected to the inner B-pillars on both sides.

In some embodiments, on the inner side of the cabin portion 3, a pair of center side crossmembers 14 may be installed on both inner sides of the central portion of the partition panel 10 so as to extend in a direction perpendicular to the height direction of the vehicle body. The center side crossmember 14 may be installed so as to be connected to the inner B-pillars on both sides. The center side crossmember 14 may extend in a direction parallel to the upper crossmember 12.

In some embodiments, on the inner side of the cabin portion 3, a center crossmember 18 may be installed between the pair of center side crossmembers 14 on the inner side of the central portion of the partition panel 10 so as to extend in a direction perpendicular to the height direction of the vehicle body. The center crossmember 18 may extend in a direction parallel to the upper crossmember 12.

In some embodiments, on the inner side of the cabin portion 3, a center lower crossmember 16 may be installed so as to extend in a direction perpendicular to the height direction of the vehicle body on the lower inner surface of the partition panel 10. Both sides of the center lower crossmember 16 may be connected to the inner B-pillars. In some embodiments, the center lower crossmember 16 may extend in a direction parallel to the upper crossmember 12, the center side crossmember 14, and the center crossmember 18.

In some embodiments, on the inner side of the cabin portion 3, a center vertical member 20 may be installed to connect the upper crossmember 12 and the center lower crossmember 16. The center vertical member 20 may be extended in the height direction of the vehicle body on the inner side of the central portion of the partition panel 10, and may be provided as a pair extending parallel to each other.

In some embodiments, one side of the center vertical member 20 may be connected to the center side crossmember 14, and the other side may be installed to connect to the center crossmember 18.

In some embodiments, on the inner side of the cabin portion 3, a lower vertical member 40 may be installed to connect the center side crossmember 14 and the center lower crossmember 16. The lower vertical member 40 may be provided as a pair extending parallel to each other to connect the pair of center side crossmembers 14 and the center lower crossmember 16, respectively.

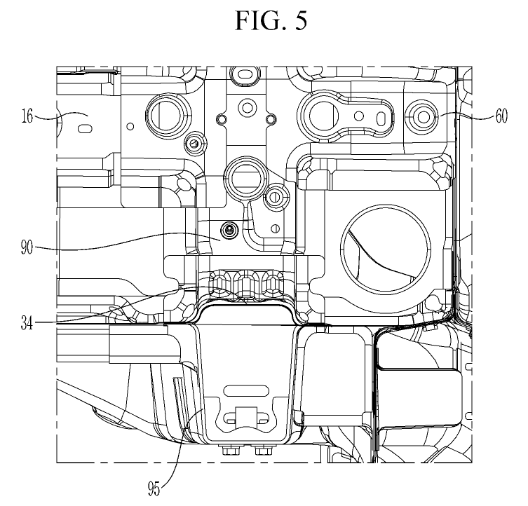

FIG. 5 is an enlarged view of a lower side reinforcement structure of a vehicle body in a vehicle body joint structure according to an example embodiment of the present disclosure.

Referring to FIGS. 4 and 5 together, in some embodiments, a lower side vertical member 90 may be installed on the inner side of the cabin portion 3 so as to connect to both sides of the center lower crossmember 16 on the lower inner surface of the partition panel 10. The upper portion of the lower side vertical member 90 may connect to the lower vertical member 40, and the lower portion of the lower side vertical member 90 may connect to the lower inner side of the vehicle body.

In some embodiments, the lower side vertical member 90 may be provided as a pair extending parallel to each other so as to connect to the pair of lower vertical members 40.

In some embodiments, a lower side bottom reinforcement 34 may be interposed between the lower portion of the lower side vertical member 90 and the lower inner side of the vehicle body. The lower side bottom reinforcement 34 may be provided as a pair on a pair of lower side vertical members 90.

In some embodiments, at positions corresponding to a pair of lower side bottom reinforcements 34, a pair of center floor side members 95 extending parallel to each other in the length direction of the vehicle body may be installed on the lower outer side of the vehicle body.

In some embodiments, both sides of the upper crossmember 12 may be fixed to the upper inner surface of the partition panel by an upper side gusset 50. In some embodiments, the upper side gusset 50 may connect the upper crossmember 12 and the inner B-pillar. The upper side gusset 50 may be provided as a pair on both ends of the upper crossmember 12.

In some embodiments, one side of the center side crossmember 14 may be fixed to the inner surface of the central portion of the partition panel 10 by a center side gusset 30. The center side gusset 30 may connect the center side crossmember 14 and the inner B-pillar. The center side gusset 30 may be provided as a pair on both ends of the center side crossmember 14.

In some embodiments, one side of the lower vertical member 40 may be fixed to the lower inner surface of the partition panel 10 by a lower side gusset 60. In some embodiments, the other side of the lower vertical member 40 may be connected to the end of the center lower crossmember 16 on the lower inner surface of the partition panel 10. The lower side gusset 60 may connect the lower side vertical member 90 and the inner B-pillar. The lower side gusset 60 may be provided as a pair, installed on the respective sides of the lower side vertical members 90.

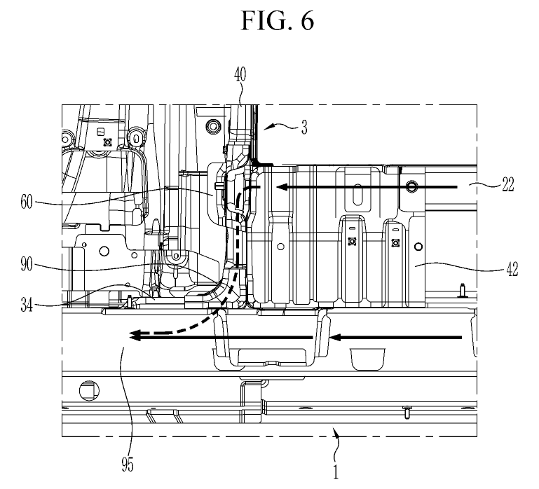

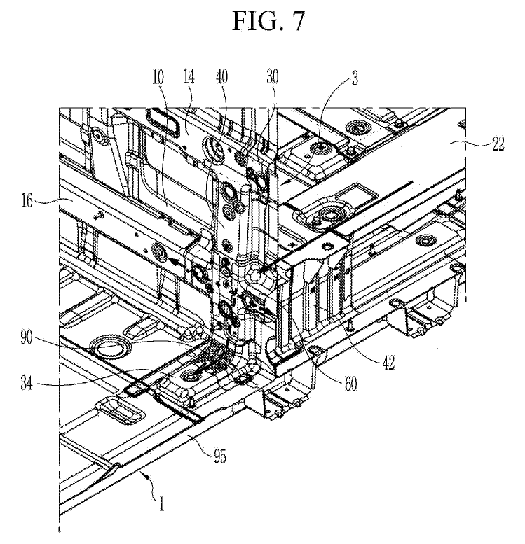

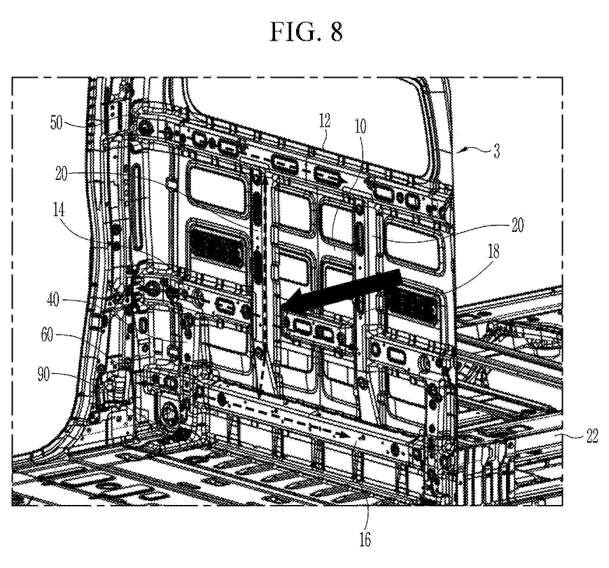

FIG. 6 illustrates a path of an impact transmitted from a lower rear portion of a vehicle body to a cabin portion in a vehicle body joint structure according to an example embodiment of the present disclosure, as viewed from the side of the vehicle. FIG. 7 illustrates a path of an impact transmitted from a lower rear portion of a vehicle body to a cabin portion in a vehicle body joint structure according to an example embodiment of the present disclosure, as viewed from the inner side of the cabin portion toward the rear of the vehicle. FIG. 8 illustrates a path of an impact transmitted from a rear center of a vehicle body to a cabin portion in a vehicle body joint structure according to an example embodiment of the present disclosure, as viewed from the inner side of the cabin portion toward the rear of the vehicle.

Referring to FIG. 6, in some embodiments, a front support reinforcement 42 may be installed on the outer side of the cabin portion 3 to support the outer surface of the cabin portion 3. In some embodiments, a side planarization member 22 may be installed so as to be connected to the upper side of the front support reinforcement 42 and extend in the length direction of the vehicle.

In some embodiments, the front support reinforcement 42 may be configured in two pieces on the front upper surface of the monocoque platform 1 and may be connected to the front end of the side planarization member 22. In some embodiments, the upper surface of the front support reinforcement 42 and the upper surface of the side planarization member 22 may be disposed to have the same height as the upper surface of the vehicle body of the CTBA mounting portion 2.

As shown in FIG. 6, in some embodiments, the impact transmitted from the rear lower portion of the vehicle body to the cabin portion 3 may enter the side planarization member 22 on the outer side of the cabin portion 3 and the center floor side member 95 on the lower portion of the vehicle.

In some embodiments, an impact that enters the side planarization member 22 on the outer side of the cabin portion 3 may pass through the front support reinforcement 42 and the partition panel 10 to the lower side vertical member 90 on the inner side of the cabin portion 3. The impact transmitted to the lower side vertical member 90 is transmitted to the lower portion of the vehicle along the lower side vertical member 90 and may be transmitted to the center floor side member 95 connected to the lower portion of the lower side vertical member 90.

In some embodiments, the impact that enters the center floor side member 95 may be continuously transmitted to the lower portion of the cabin portion 3, and may be combined with the impact that enters the side planarization member 22 so that the impact transmitted from the lower rear portion of the vehicle body is not directed directly to the inside of the cabin portion 3, but is directed to the center floor side member 95 at the lower portion of the cabin portion 3, thereby protecting the interior of the cabin portion 3 from the rear impact.

In some embodiments, as shown in FIG. 7, the impact that may enter the side planarization member 22 on the outer side of the cabin portion 3 from the lower rear portion of the vehicle body and pass through the front support reinforcement 42 and may be transmitted to the lower side vertical member 90. The impact transmitted to the lower side vertical member 90 may be transmitted in a direction perpendicular to the height direction of the vehicle body along the center lower crossmember 16 connected to one side of the lower side vertical member 90, and may also be distributed and transmitted to the lower side bottom reinforcement 34 connected to the lower portion of the lower side vertical member 90. That is, in some embodiments, the rear impact may be distributed to the center lower crossmember 16 and the lower side bottom reinforcement 34, thereby protecting the interior of the cabin portion 3 from the rear impact.

In some embodiments, as shown in FIG. 8, the impact transmitted from the rear center of the vehicle body to the cabin portion 3 may be transmitted to the center vertical member 20 on the inner side of the cabin portion 3 through the partition panel 10, and may be distributed and transmitted from the center vertical member 20 to the upper crossmember 12, the center side crossmember 14, the center lower crossmember 16, and the center crossmember 18. The impact transmitted to the upper crossmember 12, the center side crossmember 14, the center lower crossmember 16, and the center crossmember 18 may be distributed by being transmitted to the left and right directions of the vehicle, and the impact may be prevented from being concentrated on the interior of the cabin portion 3, thereby protecting the interior of the cabin portion 3 from the rear impact.

In this way, according to an example embodiment of the present disclosure, by installing a plurality of crossmembers, vertical members, and gussets on the inner side of the cabin portion in a chassis cab body type vehicle, it is possible to improve the rigidity of the vehicle body and alleviate the impact caused by a rear collision to protect the cabin portion.

In some embodiments, by securing the rigidity of the vehicle body, damage to the battery installed in the vehicle may be prevented, and the safety of passengers may be improved.

In some embodiments, the position and number of crossmembers, vertical members, and gussets may be changed to adapt to the size and shape of the vehicle, allowing for easy and flexible adaptation to multi-specification vehicle models, reducing investment and research and development costs, and increasing productivity.

While the example embodiments of the present disclosure have been described in detail, it may be understood that the present disclosure is not necessarily limited to the disclosed example embodiments, but on the contrary, the present disclosure is intended to cover various modifications and equivalent arrangements for other embodiments included within the spirit and scopes of the appended claims and equivalents thereof.

What is claimed is:

1. A vehicle body joint structure of a vehicle body comprising a chassis cab included in a cabin portion and a luggage portion connected to an outer side of the chassis cab, the vehicle body joint structure comprising:
side planarization members connected to lower ends on both sides of an outer side of the cabin portion and arranged to extend in a length direction of the vehicle body;
lower side vertical members installed on the lower ends on both sides of an inner side of the cabin portion and arranged to extend in a height direction of the vehicle body; and
a center floor side member connected to the lower side vertical member and arranged to extend in the length direction of the vehicle body.

2. The vehicle body joint structure of claim 1, further comprising a lower side gusset, wherein one end of the side planarization member is connected to the lower side vertical member by the lower side gusset.

3. The vehicle body joint structure of claim 2, further comprising a front support reinforcement installed to support an outer surface of the cabin portion, wherein the side planarization member is connected to an upper surface of the front support reinforcement.

4. The vehicle body joint structure of claim 3, further comprising a lower side bottom reinforcement interposed between the lower portion of the lower side vertical member and the lower inner side of the vehicle body.

5. The vehicle body joint structure of claim 4, further comprising:
a partition panel included in a vertical cross-section of the cabin portion; and
an upper crossmember installed on the inner side of the cabin portion and extending in a direction perpendicular to a height direction of the vehicle body on the upper inner surface of the partition panel.

6. The vehicle body joint structure of claim 5, further comprising an upper side gusset, wherein both sides of the upper crossmember are fixed to the upper inner surface of the partition panel by the upper side gusset.

7. The vehicle body joint structure of claim 5, further comprising a pair of center side crossmembers installed on the inner side of the cabin portion and extending in a direction perpendicular to the height direction of the vehicle body on both inner surfaces of a central portion of the partition panel.

8. The vehicle body joint structure of claim 7, further comprising a center side gusset, wherein one side of the center side crossmember is fixed to the inner surface of the central portion of the partition panel by the center side gusset.

9. The vehicle body joint structure of claim 7, further comprising a center crossmember installed on the inner side of the cabin portion and extending in a direction perpendicular to the height direction of the body between the pair of center side crossmembers on the inner surface of the central portion of the partition panel.

10. The vehicle body joint structure of claim 9, further comprising a center lower crossmember installed on the inner side of the cabin portion and extending in a direction perpendicular to the height direction of the vehicle body on the lower inner surface of the partition panel.

11. The vehicle body joint structure of claim 10, further comprising a center vertical member installed on the inner side of the cabin portion, extending in the height direction of the vehicle body on the inner surface of the central portion of the partition panel, and installed to connect the upper crossmember and the center lower crossmember.

12. The vehicle body joint structure of claim 11, wherein one side of the center vertical member is connected to the center side crossmember, and another side of the center vertical member is installed to be connected to the center crossmember.

13. The vehicle body joint structure of claim 10, further comprising a lower vertical member installed on the inner side of the cabin portion, and on the lower inner surface of the partition panel, installed to connect the center side crossmember and the center lower crossmember.

14. The vehicle body joint structure of claim 13, wherein an upper portion of the lower side vertical member is connected to the lower vertical member, and
wherein the lower portion of the lower side vertical member is connected to the lower inner side of the vehicle body.

15. The vehicle body joint structure of claim 14, wherein one side of the lower vertical member is fixed to the lower inner surface of the partition panel by the lower side gusset.

16. The vehicle body joint structure of claim 15, wherein another side of the lower vertical member is connected to the end of the center lower crossmember on the lower inner surface of the partition panel.

17. The vehicle body joint structure of claim 3, wherein the vehicle body joint structure is configured such that an impact transmitted from the lower rear portion of the vehicle body to the cabin portion is transmitted to the center floor side member through the side planarization member, the front support reinforcement, and the lower side vertical member.

18. The vehicle body joint structure of claim 10, wherein the vehicle body joint structure is configured such that an impact transmitted from the lower rear portion of the vehicle body to the cabin portion is transmitted to the side planarization member, the front support reinforcement, and the lower side vertical member, and the impact transmitted to the lower side vertical member is distributed and transmitted to the center lower crossmember and the lower side bottom reinforcement.

19. The vehicle body joint structure of claim 10, wherein the vehicle body joint structure is configured such that an impact transmitted from a rear center of the vehicle body to the cabin portion is distributed and transmitted from the center vertical member to the upper crossmember, the center side crossmember, the center lower crossmember, and the center crossmember.

20. A vehicle comprising:
a cabin portion of a vehicle body of the vehicle; and
a vehicle body joint structure of the vehicle body, wherein the vehicle body joint structure comprises:
side planarization members connected to lower ends on both sides of an outer side of the cabin portion and arranged to extend in a length direction of the vehicle body,
lower side vertical members installed on the lower ends on both sides of an inner side of the cabin portion and arranged to extend in a height direction of the vehicle body,
a center floor side member connected to the lower side vertical member and arranged to extend in the length direction of the vehicle body,
a lower side gusset, wherein one end of the side planarization member is connected to the lower side vertical member by the lower side gusset,
a front support reinforcement installed to support an outer surface of the cabin portion, wherein the side planarization member is connected to an upper surface of the front support reinforcement,
a lower side bottom reinforcement interposed between the lower portion of the lower side vertical member and the lower inner side of the vehicle body,
a partition panel included in a vertical cross-section of the cabin portion,
an upper crossmember installed on the inner side of the cabin portion and extending in a direction perpendicular to a height direction of the vehicle body on the upper inner surface of the partition panel,
an upper side gusset, wherein both sides of the upper crossmember are fixed to the upper inner surface of the partition panel by the upper side gusset,
a pair of center side crossmembers installed on the inner side of the cabin portion and extending in a direction perpendicular to the height direction of the vehicle body on both inner surfaces of a central portion of the partition panel,
a center side gusset, wherein one side of the center side crossmember is fixed to the inner surface of the central portion of the partition panel by the center side gusset,
a center crossmember installed on the inner side of the cabin portion and extending in a direction perpendicular to the height direction of the body between the pair of center side crossmembers on the inner surface of the central portion of the partition panel,
a center lower crossmember installed on the inner side of the cabin portion and extending in a direction perpendicular to the height direction of the vehicle body on the lower inner surface of the partition panel,
a center vertical member installed on the inner side of the cabin portion, extending in the height direction of the vehicle body on the inner surface of the central portion of the partition panel, and installed to connect the upper crossmember and the center lower crossmember, wherein one side of the center vertical member is connected to the center side crossmember, and another side of the center vertical member is installed to be connected to the center crossmember, and
a lower vertical member installed on the inner side of the cabin portion, and on the lower inner surface of the partition panel, installed to connect the center side crossmember and the center lower crossmember.
